(19) United States
(12) Patent Application Publication
(10) Pub. No.: US 2015/0176678 A1
(43) Pub. Date: Jun. 25, 2015

(54) Cord Tensioning Device

(71) Applicant: David Carl Burrell, Greenwood, SC (US)

(72) Inventor: David Carl Burrell, Greenwood, SC (US)

(21) Appl. No.: 14/577,358

(22) Filed: Dec. 19, 2014

Related U.S. Application Data
(60) Provisional application No. 61/919,550, filed on Dec. 20, 2013.

(51) Int. Cl. F16G 11/14

(52) U.S. Cl. CPC F16G 11/146

(57) ABSTRACT

A cord attachment and tensioning device includes a main body, a first eyestalk, a second eyestalk, a primary hole, and a first supplemental hole. The main body includes a top surface, a bottom surface, and a lateral surface. The lateral surface is perpendicularly connected in between the top surface and the bottom surface. The primary hole traverses through the main body and allows for cord attachment through a variety of means. The first eyestalk and the second eyestalk are adjacently connected around the lateral surface creating a depression in between them which allows for a portion of the cord to be engaged therein. The first supplemental hole traverses through the first eyestalk creating another cord engagement region.

The current application claims a priority to the U.S. Provisional Patent application Ser. No. 61/919,550 filed on Dec. 20, 2013.

### FIELD OF THE INVENTION

The present invention relates generally to cord accessories. More specifically, the present invention is a cord attachment and tensioning device. The present invention allows for quick and easy cord attachment without the use of knots, hooks, or sophisticated attachment mechanism.

### BACKGROUND OF THE INVENTION

Ropes and cords, a specific type of rope, have a high tensile strength while still being flexible, light, and highly portable. For these reasons, ropes and cords are extremely versatile in functionality across a variety of fields including construction, environmental exploration, theatre, seafaring, and sports. A cord is a specific type of rope most often times characterized by nylon strand composition. Many devices and methods have been invented to manipulate, attach, and secure cords. Among the methods are a large number of different knots, each with their own specific strengths, weaknesses, and ideal applications. Devices range from simple hooks, pulleys, winches, to more sophisticated mechanisms. Despite the variety of methods and devices, these attachment means are oftentimes bulky, time consuming, and difficult to use. It is therefore an object of the present invention to introduce a simple and effective device for cord attachment.

The present invention is device that allows for rapid cord attachment and easy adjustment with or without the necessity of tying a knot. Being lightweight and small, the present invention is ideal in activities such as camping and/or hiking where a lightweight backpack is preferred. With the use of the present invention, a cord may be fastened to any item with increased efficiency through a couple of simple steps. Furthermore, the unique design lends itself to a multitude of uses and attachment means.

### BRIEF DESCRIPTION OF THE DRAWINGS

FIG. 1 is a perspective view of the present invention.

FIG. 2 is a front view of the present invention.

FIG. 3 is a perspective view of an alternative embodiment of the present invention.

FIG. 4 is a front view of an alternative embodiment of the present invention.

FIG. 5 is a perspective view of a cord in use with the present invention.

### DETAIL DESCRIPTIONS OF THE INVENTION

All illustrations of the drawings are for the purpose of describing selected versions of the present invention and are not intended to limit the scope of the present invention.

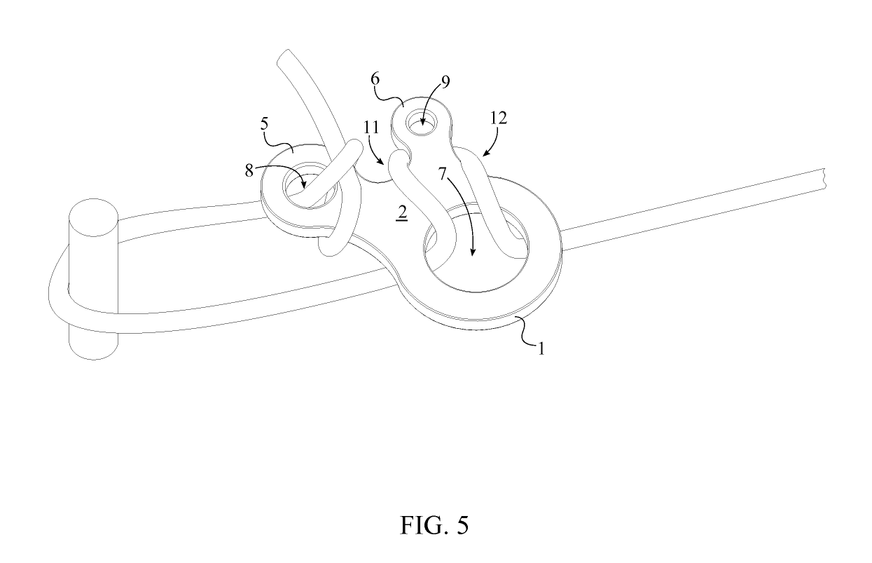

The present invention is a cord attachment and tensioning device. The present invention allows a cord to be efficiently and effectively attached to an item with or without typing a knot; traditional knots are known for being cumbersome and time consuming to tie and untie. The design of the present invention lends itself to a multitude of attachment methods and tying configurations. The main attachment method is illustrated in FIG. 5. This method is easy to remember, simple to execute, and does not require the use of a traditional knot. Furthermore, the preferred attachment method allows for easy length and tension adjustment. The present invention may be used on tents, canopies, backpacks, cargo, tarps, and strollers to name a few. To withstand the stresses and strains, the present invention may be composed of a rigid material including, but not limited to, aluminum, titanium, stainless steel, or any combination thereof to name a few non-limiting examples.

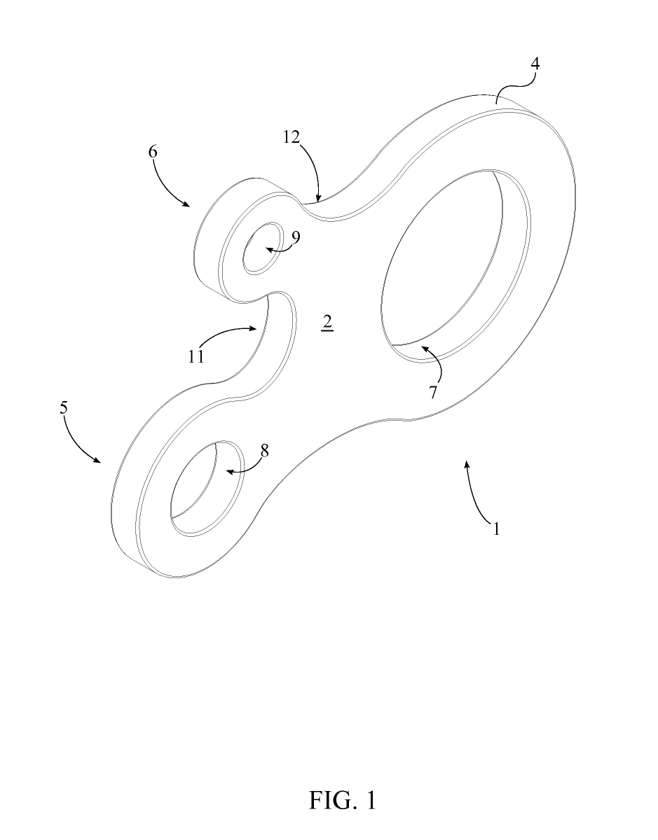

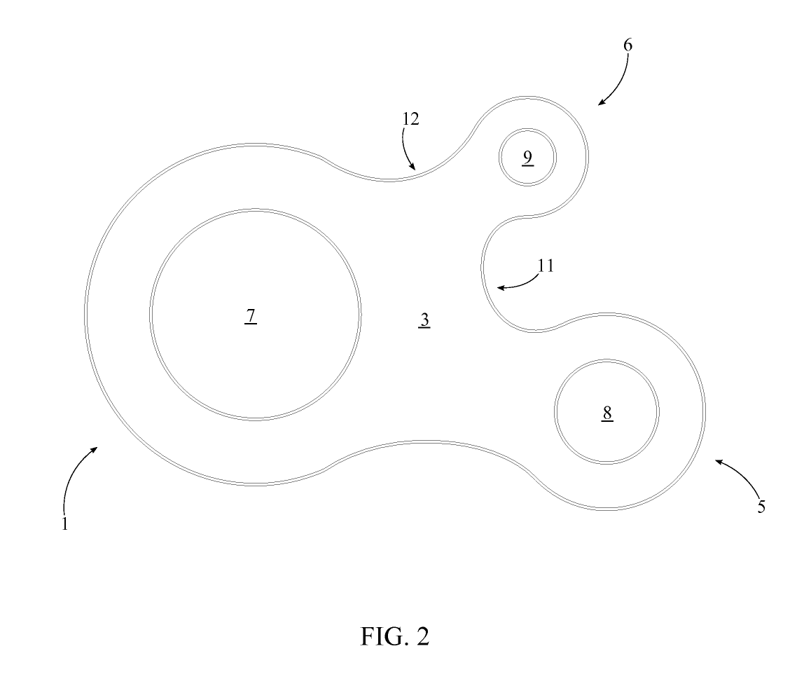

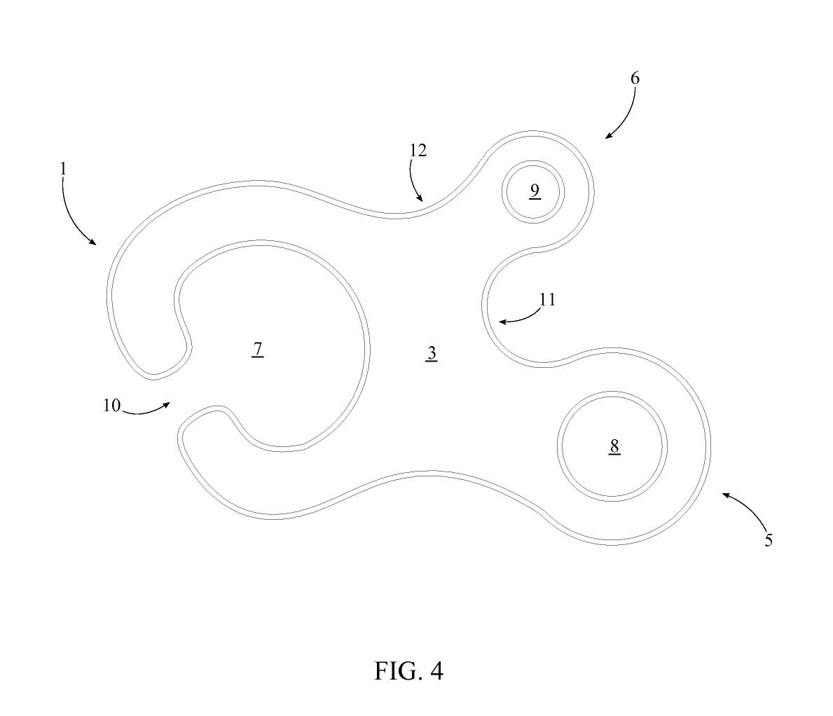

Referring to FIG. 1, the present invention comprises a main body 1, a first eyestalk 5, a second eyestalk 6, a primary hole 7, and a first supplemental hole 8. The main body 1 and the primary hole 7 form a region that a cord may be tied to, tied around, interlocked, fed through, or engaged in some manner. Similarly, the first eyestalk 5 and the first supplemental hole 8 form another region that a cord may engage; for example, a single end of the cord may be tied to the first eyestalk 5 and the first supplemental hole 8. The second eyestalk 6 protrudes from the main body and provides another engagement point for the cord; the second eyestalk 6 may be used as a hitch-like device to increase the engagement surface between the cord and the present invention. One particular reason for increasing the engagement surface with the first eyestalk 5 and the second eyestalk 6 is to increase the friction between the two surfaces which allows for a more secure hold, knot, tie, or engagement. The main body 1 comprises a top surface 2, a bottom surface 3, and a lateral surface 4. The top surface 2 and the bottom surface 3 are oriented parallel and offset to each other. The lateral surface 4 is perpendicularly connected in between the top surface 2 and the bottom surface 3. The primary hole 7 traverses through the main body 1 from the top surface 2 to the bottom surface 3 and is preferably shaped similar to the outline of the cross-section of the main body 1 as seen in FIG. 2 and FIG. 4. The first supplemental hole 8 traverses through the first eyestalk 5 and is oriented parallel to the primary hole 7 as seen in FIG. 1. The first eyestalk 5 and the second eyestalk 6 are adjacently connected around the lateral surface 4 to allow for multiple attachment and engagement points for the cord.

Referring to FIG. 1 and FIG. 2, the preferred embodiment of the present invention further comprises a second supplemental hole 9, a first recessed groove 11, and a second recessed groove 12. Additionally, the cross-section of the main body 1's has a circular shape and is oriented parallel to the top surface 2 and the bottom surface 3 as seen in FIG. 2. The circular cross-section ensures there are no corners or sharp angles that the cord could press against. Sharp angles and corners could dig into the cord and potentially, over time, cause wear and tear on the cord. The second supplemental hole 9 traverses through the second eyestalk 6 and is oriented parallel to the primary hole 7. The second supplemental hole 9 creates an additional region to which the cord may be attached to; in some attachment methods the second supplemental hole 9 and the second eyestalk 6 are used to tie an additional cord to the present invention yielding a more versatile design. In the preferred embodiment, the first eyestalk 5 and the second eyestalk 6 are positioned adjacent to each other about the lateral surface 4 such that the first recessed groove 11 is created in between as seen in FIG. 2. The first recessed groove 11 and the second recessed groove 12 may be used as a guide for the cord to produce improved engagement while the user secures the cord. Once the cord is secured, the first recessed groove 11 and the second recessed 12 groove prevent the cord from slipping off and/or disengaging the present invention. The first recessed groove 11 is integrated into the lateral surface 4 in between the first eyestalk 5 and the second eyestalk 6. In a similar fashion, the second recessed space is integrated into the lateral surface 4 and positioned adjacent to the second eyestalk 6, opposite to the first recessed space as seen in FIG. 2. The first recessed groove 11 and the second recessed groove 12 are rounded such that there are no sharp angles; the radii of the first recessed groove 11 and the second recessed groove 12 may vary depending on the specific needs and requirements of the user.

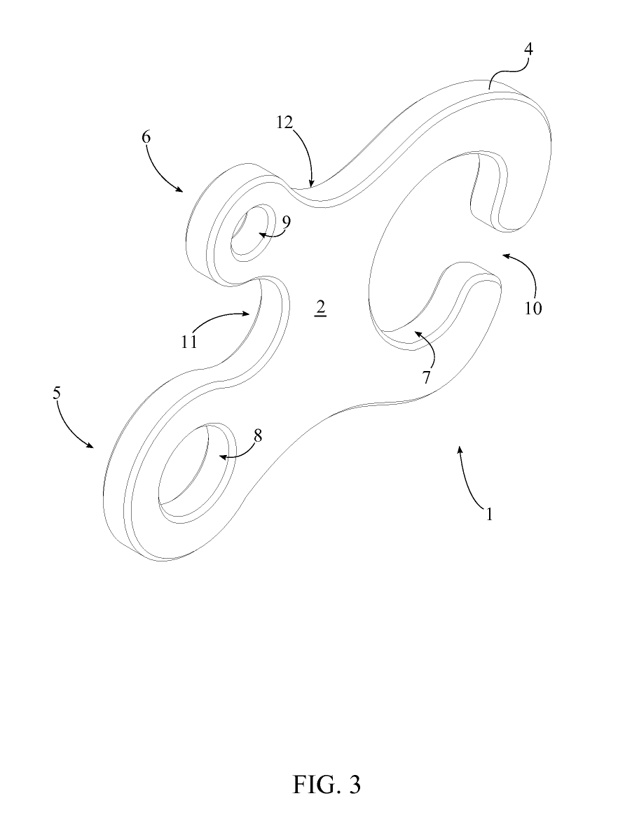

Referring to FIG. 3 and FIG. 4, in an alternative embodiment, the present invention further comprises a passageway 10 and takes on an alternative shape. The passageway 10 traverses into the main body 1 from the lateral surface 4 to the primary hole 7. Through the use of the passageway 10 the cord may be fed through the primary hole 7 and engaged to the various components of the present invention quicker and more efficiently. The alternative shape is the result of the main body 1's cross-section being of an oblong shape. The oblong cross-section is oriented parallel to the top surface 2 and the bottom surface 3. The oblong shape in conjunction with the passageway 10 create two hook-like ends in the main body 1, seen in FIG. 4, which aid in keeping the cord from slipping out of the primary hole 7 during attachment and adjustment processes. Additional features that may be incorporated into the present invention also include rounded or chamfered edges. In one embodiment of the present invention, the edges of the main body 1, the first eyestalk 5, and the second eyestalk 6 are rounded edges as seen in FIG. 1. In another embodiment of the present invention, the edges of the main body 1, the first eyestalk 5, and the second eyestalk 6 are chamfered edges as seen in FIG. 3.

As mentioned above, the present invention lends itself to be used in a plurality of different means but does have a main attachment method. The main attachment method is a quick and easy way to create an adjustable loop with the cord that may be wrapped around an item as seen in FIG. 5. The first step of the method includes attaching one end of the cord to the first eyestalk 5 through either a knot or an alternative means. One alternative means includes the cord being fed through the first supplemental hole 8, wrapped around the first eyestalk 5, and inserted in between itself and the first eyestalk 5 as illustrated in FIG. 5. Next, a certain length of the cord is measured out from said cord end to the required needs of the user and wrapped around the item such as a pole or tree trunk. Continuing the method, a small loop is created by pinching two adjacent points of the cord together and feeding said small loop through the primary hole 7, positioning said loop over the second eyestalk 6, and adjusting to the necessary tension. The tension in the cord ensures that the present invention is securely attached to the cord at both points of contact. Temporarily removing the tension allows the cord to slip though the present invention and readjusted.

Although the invention has been explained in relation to its preferred embodiment, it is to be understood that many other possible modifications and variations can be made without departing from the spirit and scope of the invention as hereinafter claimed.

What is claimed is:

1. A cord attachment and tensioning device comprises:
a main body;
a first eyestalk;
a second eyestalk;
a primary hole;
a first supplemental hole;
the main body comprises a top surface, a bottom surface, and a lateral surface;
the lateral surface being perpendicularly connected in between the top surface and the bottom surface;
the primary hole traversing through the main body from the top surface to the bottom surface;
the first eyestalk and the second eyestalk being adjacently connected around the lateral surface;
the first supplemental hole traversing through the first eyestalk; and
the first supplemental hole being oriented parallel to the primary hole.

2. The cord attachment and tensioning device as claimed in claim 1 comprises:
a second supplemental hole;
the second supplemental hole traversing through the second eyestalk; and
the second supplemental hole being oriented parallel to the primary hole.

3. The cord attachment and tensioning device as claimed in claim 1 comprises:
an oblong cross-section of the main body; and
the oblong cross-section being oriented parallel to the top surface and the bottom surface.

4. The cord attachment and tensioning device as claimed in claim 3 comprises:
a passageway; and
the passageway traversing into the main body from the lateral surface to the primary hole.

5. The cord attachment and tensioning device as claimed in claim 1 comprises:
a circular cross-section of the main body; and
the circular cross-section being oriented parallel to the top surface and the bottom surface.

6. The cord attachment and tensioning device as claimed in claim 1 comprises:
the first eyestalk and the second eyestalk being positioned adjacent to each other about the lateral surface.

7. The cord attachment and tensioning device as claimed in claim 6 comprises:
a first recessed groove;
a second recessed groove;
the first recessed groove being integrated into the lateral surface in between the first eyestalk and the second eyestalk;
the second recessed groove being integrated into the lateral surface; and
the second recessed space being positioned adjacent to the second eyestalk, opposite to the first recessed space.

8. The cord attachment and tensioning device as claimed in claim 1, wherein edges of the main body, the first eyestalk, and the second eyestalk are chamfered edges.

9. The cord attachment and tensioning device as claimed in claim 1, wherein edges of the main body, the first eyestalk, and the second eyestalk are rounded edges.

10. A cord attachment and tensioning device comprises:
a main body;
a first eyestalk;
a second eyestalk;
a primary hole;
a first supplemental hole;
a second supplemental hole;
the main body comprises a top surface, a bottom surface, and a lateral surface;
the lateral surface being perpendicularly connected in between the top surface and the bottom surface;
the primary hole traversing through the main body from the top surface to the bottom surface;
the first eyestalk and the second eyestalk being adjacently connected around the lateral surface;
the first supplemental hole traversing through the first eyestalk;
the first supplemental hole being oriented parallel to the primary hole;
the second supplemental hole traversing through the second eyestalk; and
the second supplemental hole being oriented parallel to the primary hole.

11. The cord attachment and tensioning device as claimed in claim 10 comprises:
a passageway;
an oblong cross-section of the main body;
the oblong cross-section being oriented parallel to the top surface and the bottom surface; and
the passageway traversing into the main body from the lateral surface to the primary hole.

12. The cord attachment and tensioning device as claimed in claim 10 comprises:
a circular cross-section of the main body; and
the circular cross-section being oriented parallel to the top surface and the bottom surface.

13. The cord attachment and tensioning device as claimed in claim 10 comprises:
a first recessed groove;
a second recessed groove;
the first recessed groove being integrated into the lateral surface in between the first eyestalk and the second eyestalk;
the second recessed groove being integrated into the lateral surface;
the second recessed space being positioned adjacent to the second eyestalk, opposite to the first recessed space; and
the first eyestalk and the second eyestalk being positioned adjacent to each other about the lateral surface.

14. The cord attachment and tensioning device as claimed in claim 10, wherein edges of the main body, the first eyestalk, and the second eyestalk are chamfered edges.

15. The cord attachment and tensioning device as claimed in claim 10, wherein edges of the main body, the first eyestalk, and the second eyestalk are rounded edges.

16. A cord attachment and tensioning device comprises:
a main body;
a first eyestalk;
a second eyestalk;
a primary hole;
a first supplemental hole;
a second supplemental hole;
a first recessed groove;
a second recessed groove;
the main body comprises a top surface, a bottom surface, and a lateral surface;
the lateral surface being perpendicularly connected in between the top surface and the bottom surface;
the primary hole traversing through the main body from the top surface to the bottom surface;
the first eyestalk and the second eyestalk being adjacently connected around the lateral surface;
the first supplemental hole traversing through the first eyestalk;
the first supplemental hole being oriented parallel to the primary hole;
the second supplemental hole traversing through the second eyestalk;
the second supplemental hole being oriented parallel to the primary hole;
the first recessed groove being integrated into the lateral surface in between the first eyestalk and the second eyestalk;
the second recessed groove being integrated into the lateral surface;
the second recessed space being positioned adjacent to the second eyestalk, opposite to the first recessed space; and
the first eyestalk and the second eyestalk being positioned adjacent to each other about the lateral surface.

17. The cord attachment and tensioning device as claimed in claim 16 comprises:
a passageway;
an oblong cross-section of the main body;
the oblong cross-section being oriented parallel to the top surface and the bottom surface; and
the passageway traversing into the main body from the lateral surface to the primary hole.

18. The cord attachment and tensioning device as claimed in claim 16 comprises:
a circular cross-section of the main body; and
the circular cross-section being oriented parallel to the top surface and the bottom surface.

19. The cord attachment and tensioning device as claimed in claim 10, wherein edges of the main body, the first eyestalk, and the second eyestalk are chamfered edges.

20. The cord attachment and tensioning device as claimed in claim 10, wherein edges of the main body, the first eyestalk, and the second eyestalk are rounded edges.
